(19) United States
(12) Patent Application Publication
(10) Pub. No.: US 2010/0067156 A1
(43) Pub. Date: Mar. 18, 2010

(54) ELECTRICAL BARRIER

(75) Inventor: Peter Lark, Lancashire (GB)

Correspondence Address: BARLOW, JOSEPHS & HOLMES, LTD., 101 DYER STREET, 5TH FLOOR, PROVIDENCE, RI, 02903, US

(73) Assignee: PEPPERL & FUCHS, Lancashire (GB)

(21) Appl. No.: 12/518,570

(22) PCT Filed: May 23, 2007
(86) PCT No.: PCT/GB2007/001891

§ 371 Date: Oct. 1, 2009

(30) Foreign Application Priority Data
May 23, 2006 (GB) 060102.4

(51) Int. Cl. H02H 9/00

(52) U.S. Cl. 361/57; 361/54

(57) ABSTRACT

An electrical barrier for connecting a power supply to electrical equipment to be used in a potentially explosive area. The barrier includes a shunt zener diode for limiting the output voltage and a series resistance for limiting the current. In the arrangement shown, the shunt zener diode is a silicon carbide zener diode which has a higher resistance to large output current and/or operating temperature than zener diodes fabricated commercially.

The present invention relates to an electrical barrier suitable for use between a power supply in a safe area and intrinsically safe circuitry in a hazardous (potentially explosive) atmosphere.

The operation of electrical equipment in potentially explosive atmospheres carries the risk of triggering an explosion. In order to reduce this risk, the concept of intrinsic safety is used. This involves limiting the energy used by any electrical equipment in a potentially explosive atmosphere to a level that cannot cause ignition. Typically this is achieved by connecting an electrical barrier between a power supply and the equipment used in the potentially explosive atmosphere often with the use of additional circuitry e.g. galvanic isolation. Electrical barrier circuits may also be used in other applications such as suppression of electrical surges due to lightning strikes.

A conventional barrier comprises a zener diode (typically a plurality of zener diodes) provided as a shunt so as to limit the maximum voltage that may be supplied to the equipment. A series fuse is provided to prevent overload of the zener diodes. Additionally a series resistance is provided on the output side of the barrier to limit the maximum current supplied to the equipment to the zener diode voltage divided by the series resistance.

This can thus reduce the energy in any equipment in the potentially explosive atmosphere to a safe level as the energy stored in any capacitance in the equipment is limited by the voltage it can be charged to and similarly the energy stored in any inductance is limited by the current.

If the voltage on the zener diode is too high, the resulting shunt current would reduce signal accuracy and if high enough would blow the fuse. The voltage must be set low enough that the zener diodes do not conduct too much over the full range of likely operating temperatures. Conventional Zener diodes, formed from suitably doped silicon, have a low temperature tolerance, typically 150-175° C., a low thermal conductivity and a significant temperature coefficient. This reduces the signal level that can safely be used and accordingly limits the application of such barrier circuits.

It is therefore an object of the present invention to provide a new and improved electrical barrier for use between a power supply and electrical equipment used in a potentially explosive area.

According to the present invention there is provided an electrical barrier comprising: an input adapted to be connected to a power supply and an output adapted to be connected to electrical equipment; at least one shunt zener diode for limiting the output voltage; and an output series resistance for limiting the output current wherein the shunt zener diode is a silicon carbide zener diode.

This arrangement provides an electrical barrier suitable for use between a power supply and electrical equipment which is operable at a larger range of input voltages and local temperatures than a conventional barrier circuit incorporating a silicon zener diode.

Typically, in prior art barriers, a plurality of silicon zener diodes are provided in series, so as to limit the maximum power applied to any one of the diodes. As a silicon carbide zener diode has a much higher temperature tolerance, thermal conductivity and maximum current density than a silicon zener diode a plurality of such silicon diodes may be replaced by a single silicon carbide zener diode, thus reducing the size of the barrier circuit.

The use of one higher voltage silicon carbide zener allows the barrier to be operated at a higher voltage than multiple lower voltage zeners (of the same total voltage) for a given leakage current. The lower temperature coefficient of the silicon carbide zener diode also means that the barrier can be operated at a higher voltage across the operating temperature range. The higher current carrying capacity of silicon carbide zener diodes allows a reduced semiconductor size with reduced leakage current for a given voltage.

A series fuse may be provided to prevent overload of the zener diode. Additionally or alternatively, a series resistance may be provided on the output side of the barrier to limit the maximum current supplied to the equipment to the zener diode voltage divided by the series resistance.

A sensing resistance may be provided in series with the zener diode or diodes and means may be provided for regulating the input voltage in response to current flowing through the sensing resistance. Further details of the composition and operation of such barrier may be found in the disclosure of our co-pending European patent application no 06250333.9, the disclosure of which is hereby incorporated by reference.

The barrier may be a two wire barrier. In alternative embodiments, the barrier may be a multiple wire barrier. The barrier may comprise an electrical barrier suitable for use between a power supply and electrical equipment in a potentially explosive atmosphere. The barrier may comprise an electrical barrier suitable for use as a surge suppresser. In particular, the surge suppresser may be adapted for suppressing surges in intrinsically safe control circuits. The use of silicon carbide zener diodes would reduce the requirements on the other components.

The barrier may comprise a lightning protection barrier. Such a barrier may comprise one or more inductors in series with the one or more zener diodes and a spark gap in parallel with one or more zener diodes. The spark gaps allow sparks to break and thus attenuate the current applied to the barrier by a lightning strike and the inductors and zener diodes attenuate the voltage from the spark gap. The barrier may be grounded via a busbar.

In order that the invention is more clearly understood, it will now be described in greater detail below, by way of example only, with reference to the drawings, in which:-

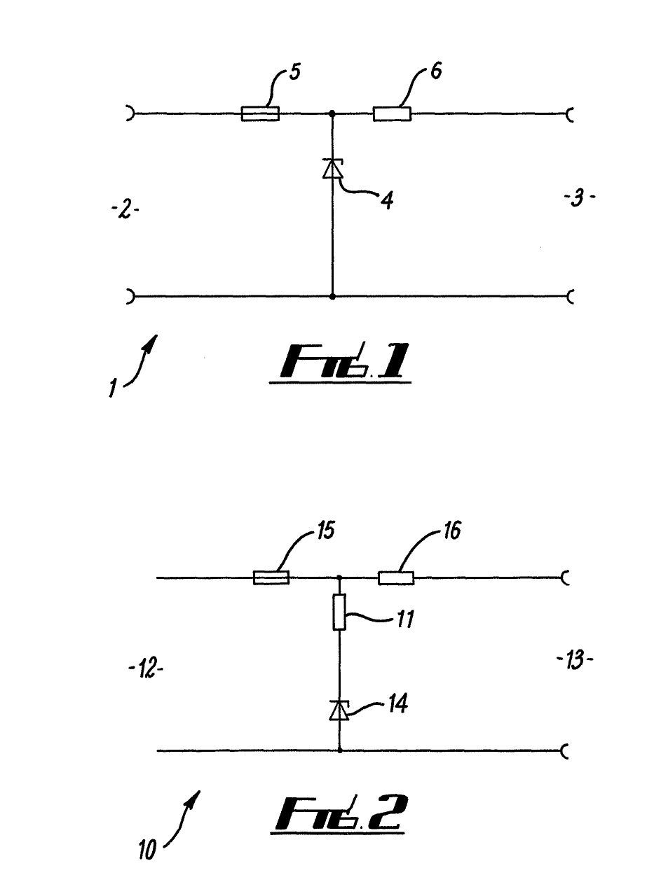

FIG. 1 is a schematic diagram of an electrical barrier according to the present invention;

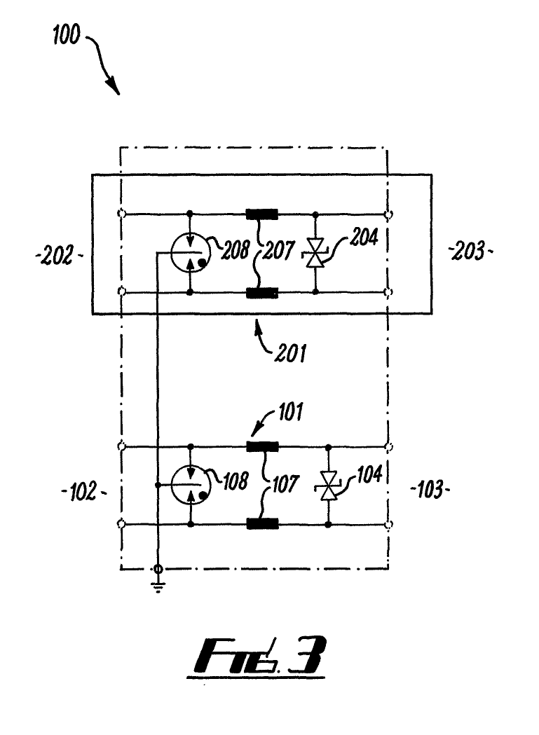

FIG. 2 is a schematic diagram of an alternative electrical barrier according to the present invention; and

FIG. 3 is a schematic diagram of a lightning barrier according to the present invention.

Referring now to FIG. 1, an electrical barrier 1 for connecting a power supply to electrical equipment in a potentially explosive atmosphere comprises an input 2 and an output 3. In between said input and said output are provided a shunt zener diode 4, a fuse 5 and an output resistor 6. The zener diode 4 is operable to limit the output voltage of the barrier and may in some embodiments comprise a plurality of zener diodes, if desired or appropriate. The output resistor 6 is operable to limit the maximum output current whilst the fuse 5 is operable to prevent operation of the barrier if an excessive load is input.

In the present invention, the zener diode 4 is a zener diode formed from silicon carbide rather than a zener diode formed from silicon. Accordingly, the zener diode can tolerate a much larger input current density and/or operating temperature. Additionally, the silicon carbide diode has a much higher thermal conductivity and a much lower temperature coefficient, further enabling the device to tolerate higher temperatures. Given these properties, it is possible to replace a plurality of silicon zener diodes in series with a single silicon carbide zener diode. This enables the construction of barriers which are smaller. In particularly preferred embodiment the silicon carbide zener diode may be a 24V zener diode capable of carrying 85 mA or more. Such a zener diode may have a small temperature coefficient and may fit on a 100 μm dimension die.

Referring now to FIG. 2, an alternative electrical barrier 10 comprises an input 12, output 13 a shunt zener diode 14, a fuse 15, an output resistor 16 and a sensing resistor 11. As in the above embodiment, the zener diode 14 is a silicon carbide zener diode operable to limit the output voltage of the barrier and may in some embodiments comprise a plurality of silicon carbide zener diodes, if desired or appropriate. The output resistor 16 is operable to limit the maximum output current whilst the fuse 15 is operable to prevent operation of the barrier in the event of an excessive input.

The sensing resistor 11, being in series with the zener diode 14 allows the current flowing through the zener diode 14 to be determined. The voltage on the zener diode 14 can then be controlled so that a desired current flows. It is of course to be understood that a plurality of sensing resistors in parallel can be used, as an alternative or as necessary. Additionally, it is clear that the sensing resistor 11 does not necessarily have to be on the positive side of the zener diode 14.

Referring now to FIG. 3, a lightning barrier according to the present invention for the protection of up to two independent circuits is shown. The barrier 100, comprises a pair of individual barrier circuits 101 and 201. In embodiments wherein it is desired to protect only a single circuit, the second barrier circuit 201 may be omitted. Each individual barrier circuit 101, 201 comprises an input 102, 202 and an output 103, 203. In between said input 102, 202 and said output 103, 203 are provided a shunt zener diode 104, 204, a pair of inductors 107, 207, and a spark gap 108, 208. The zener diode 104, 204 may, in some embodiments, comprise a plurality of zener diodes, if desired or appropriate. As in the previous embodiments of the present invention, the zener diode or diodes are silicon carbide zener diodes.

When a lightning strike occurs, the inductors 107 limit the rate of rise of current into the zener diode 104 the spark gap 108 breaks and absorbs the majority of the current associated with lightning strike.

It will of course be understood that the invention is not intended to be restricted to the details of the above embodiment which is described by way of example only.

Thus, for example, the present invention can alternatively be regarded as a new use of a known material. This use of silicon carbide in many areas is known because of its properties (it is a very hard material akin to diamond).

However, there was no appreciation of the fact that use of silicon carbide for diodes in the circuit of the types of the present invention would offer an advantage.

1. An electrical barrier, comprising:
an input adapted to be connected to a power supply; and
an output adapted to be connected to electrical equipment, at least one shunt zener diode for limiting the output voltage and an output series resistance limiting the output current wherein the shunt zener diode is a silicon carbide zener diode.

2. The electrical barrier according to claim 1, wherein a series fuse is provided to prevent overload of the zener diode.

3. The electrical barrier according to claim 2, wherein a series resistance provided on the output side of the barrier to limit the maximum current supplied to the equipment to the zener diode voltage divided by the series resistance.

4. The electrical barrier according to claim 1, further comprising a sensing resistance in series with the zener diode or diodes and means is provided for regulating the input voltage in response to current flowing through the sensing resistor.

5. The electrical barrier according to claim 4, wherein the electrical barrier is formed as a two wire barrier.

6. The electrical barrier according to claim 5, wherein the electrical barrier is formed as a multiple wire barrier.

7. The electrical barrier according to claim 6, further comprising: a surge suppressor, said surge suppressor suppressing surges in intrinsically safe control circuits.

8. The electrical barrier according to claim 7, further comprising a lightning protection barrier.

9. The electrical barrier according to claim 8, wherein one or more inductors are provided in series with one or more zener diodes and a spark gap in parallel with one or more zener diodes.

10. The electrical barrier according to claim 9, wherein the barrier is grounded via a busbar arrangement.
